(19) United States
(12) Patent Application Publication
(10) Pub. No.: US 2026/0348463 A1
(43) Pub. Date: Nov. 5, 2026

(54) DIFFERENTIAL DEVICE

(71) Applicant: Hitachi Astemo, Ltd., Hitachinaka-shi, Ibaraki (JP)

(72) Inventors: Akira NAKAMURA, Hitachinaka-shi (JP); Fumio OSHIMA, Hitachinaka-shi (JP); Takashi SEKO, Hitachinaka-shi (JP)

(21) Appl. No.: 19/108,030

(22) PCT Filed: Nov. 17, 2022
(86) PCT No.: PCT/JP2022/042771

§ 371 Date: Feb. 28, 2025

(51) Int. Cl. F16H 48/08; F16H 48/40

(52) U.S. Cl. CPC F16H 48/08; F16H 48/40; F16H 2048/085

(57) ABSTRACT

A differential device includes: a differential case to rotate about a first rotating axis and having a spherical shell along the first rotating axis; a first pinion gear pair to rotate about a second rotating axis orthogonal to the first rotating axis and disposed inside the differential case; a second pinion gear pair to rotate about a third rotating axis orthogonal to the first rotating axis and the second rotating axis and disposed inside the differential case; a side gear pair meshing at right angles with the first pinion gear pair and the second pinion gear pair, to rotate about the first rotating axis, and disposed to be rotatable relative to the differential case and a pinion gear supporting member disposed on a rear surface of the second pinion gear pair and installed in an opening portion formed in the differential case and closer to the first rotating axis than an end surface of a pinion gear supporting shaft which supports the second pinion gear pair on the third rotating axis.

### CROSS-REFERENCE TO RELATED APPLICATION

This application is a U.S. National Stage Application under 35 U.S.C. § 371 of International Patent Application No. PCT/JP2022/042771 filed on 17 Nov. 2022, the disclosure of which is hereby incorporated by reference in its entirety.

### TECHNICAL FIELD

The present invention relates to a differential device.

### BACKGROUND ART

A two-pinion differential device using two pinion gears is used in general as a differential device for conducting a differential action between left and right wheels or a differential action between front and rear wheels of a vehicle. In the case where torque to be inputted is high, a four-pinion differential device (differential device) using four pinion gears is used in order to reduce a load applied to pinion gears to ensure durability (for example, see Patent Literature 1).

A differential device is incorporated in a front wheel drive transmission (a transaxle) or a final reduction gear which drives rear wheels. A differential device includes a differential case which has a spherical shell shape, a ring gear which is fitted onto the differential case, a pair of pinion gears which are housed in the differential case, a pair of side gears which are housed in the differential case, and pinion shafts which are fitted in the differential case.

The pinion gears are each disposed to be rotatable about a rotating axis which is disposed to be orthogonal to a rotating axis of the differential case. The pair of side gears mesh with the pinion gears, are disposed on the same axis as the differential case, and are housed in the differential case to be capable of rotating relative to the differential case. The pinion shafts support the pinion gears.

Here, in order to incorporate the pinion gears and the side gears in the differential case for a two-pinion differential device, the differential case has opening portions at positions shifted by 90 degrees from positions at which the pinion gears are disposed in a direction of the rotating axis of the differential case. For this reason, the differential case for a two-pinion differential device cannot be used as it is for a four-pinion differential device. In general, as described in Patent Literature 1, a four-pinion differential device does not have opening portions for obtaining pinion gear seating surfaces of differential cases, and the differential cases are constructed to be separable in the direction of the rotating axis, and are fastened together with bolts for fixing a ring gear.

### CITATION LIST

### Patent Literature

Patent Literature 1: JP2007-270947A

### SUMMARY OF INVENTION

### Technical Problem

However, when the four-pinion differential device described in Patent Literature 1 is constructed such that one pinion shaft and two other pinion shafts are incorporated in a cross shape inside the differential cases, the differential cases are composed with two components. For this reason, the number of components, the number of steps of processing, and the number of steps of assembly increase, and the four-pinion differential device has a problem that the cost is increased.

In addition, the ring gear fixation holes through which the ring gear fastening bolts are inserted are required to have high precision in hole diameters and positions, and co-processing of simultaneously processing two differential cases is thus required. Besides, it is also required to screw small screws for temporarily fastening two differential cases in steps until the ring gear is attached, and the four-pinion differential device has a problem that the productivity decreases.

To solve the problems, a four-pinion differential device which has a differential case composed with a single component, and which further makes it possible to use the component of the differential case in common with a two-pinion differential device, and can prevent an increase in cost and a decrease in productivity has been demanded.

The present invention has been created to solve such problems, and an object of the present invention is to provide a four-pinion differential device which can reduce the number of components and achieve a reduction in cost.

### Solution to Problem

To achieve the above-described object, a differential device according to the present invention comprises: a differential case which is to rotate about a first rotating axis, and has a spherical shell shape along a direction of the first rotating axis; a first pinion gear pair which is to rotate about a second rotating axis orthogonal to the first rotating axis, and is disposed inside the differential case; a second pinion gear pair which rotates about a third rotating axis orthogonal to the first rotating axis and the second rotating axis, and is disposed inside the differential case; a side gear pair which meshes at right angles with the first pinion gear pair and the second pinion gear pair, rotates about the first rotating axis, and is disposed to be rotatable relative to the differential case; and at least one pinion gear supporting member which is disposed on a rear surface of the second pinion gear pair, and is installed in an opening portion formed in the differential case and closer to the first rotating axis than an end surface of a pinion gear supporting shaft which supports the second pinion gear pair on the third rotating axis.

### Advantageous Effects of Invention

The differential device of the present invention makes it possible to provide a four-pinion differential device which can reduce the number of components and achieve a reduction in cost.

### BRIEF DESCRIPTION OF DRAWINGS

FIG. 1 is a main part-transverse sectional view showing a differential device according to a first embodiment of the present invention.

FIG. 2 is a main part-longitudinal sectional view showing the differential device according to the first embodiment of the present invention.

FIG. 3 is a side view showing the differential device according to the first embodiment of the present invention.

FIG. 4 is a main part-exploded perspective view showing the differential device according to the first embodiment of the present invention.

FIG. 5 is a main part-perspective view showing the differential device according to the first embodiment of the present invention.

FIG. 6 is a main part-perspective view showing the differential device according to the first embodiment of the present invention, and showing a state in which a pinion gear supporting member has been removed.

FIG. 7 is a main part-enlarged perspective view showing a state in which a snap ring has been attached.

FIG. 8 is an enlarged perspective view showing a pair of snap rings.

FIG. 9 is a main part-transverse sectional view showing a differential device according to a second embodiment of the present invention.

FIG. 10 is a main part-transverse sectional view showing the differential device according to the second embodiment of the present invention, and showing a state in which a side gear pair is mounted on a differential case.

FIG. 11 is a main part-exploded perspective view showing the differential device according to the second embodiment of the present invention.

FIG. 12 is a main part-transverse sectional view showing a differential device according to a third embodiment of the present invention.

FIG. 13 is a main part-transverse sectional view showing the differential device according to the third embodiment of the present invention, and showing a state in which a side gear pair has been mounted on a differential case.

FIG. 14 is a main part-exploded perspective view showing the differential device according to the third embodiment of the present invention.

FIG. 15 is a schematic view showing a modification of the snap ring of the differential device according to the first embodiment of the present invention, and showing the shape of the snap ring.

### DESCRIPTION OF EMBODIMENTS

### First Embodiment

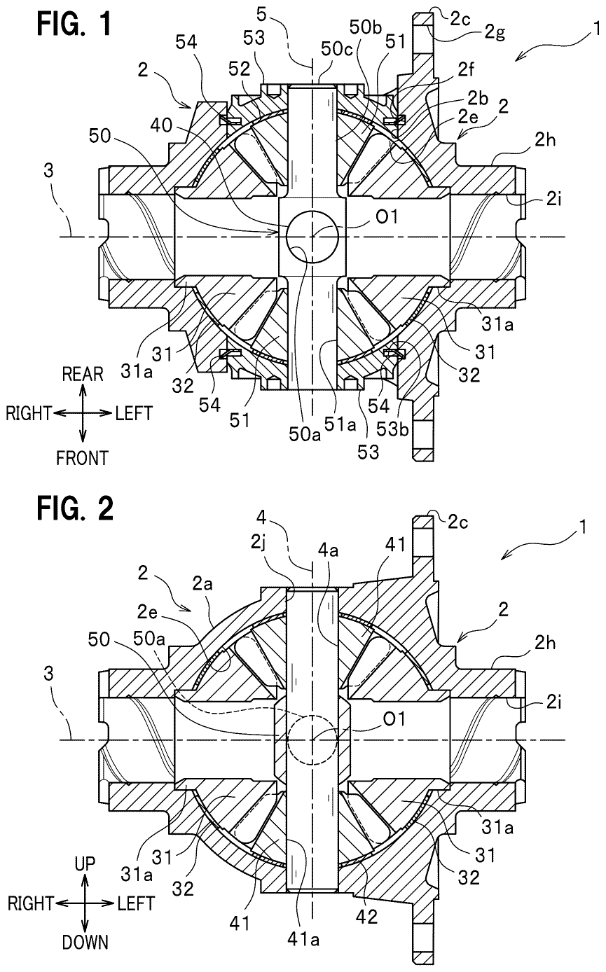

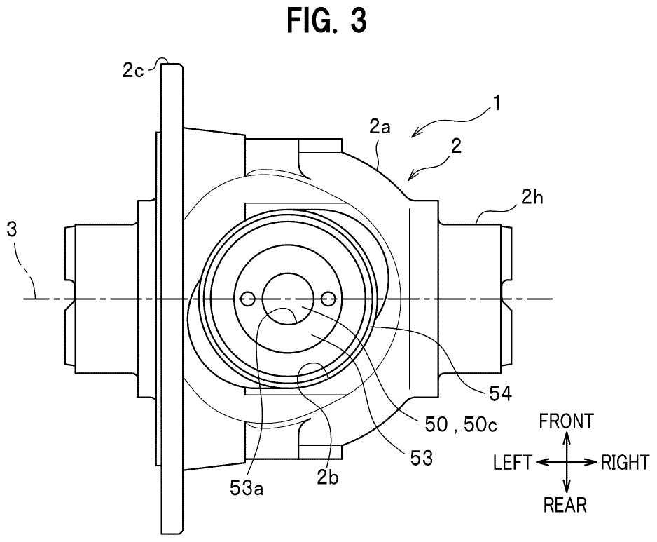

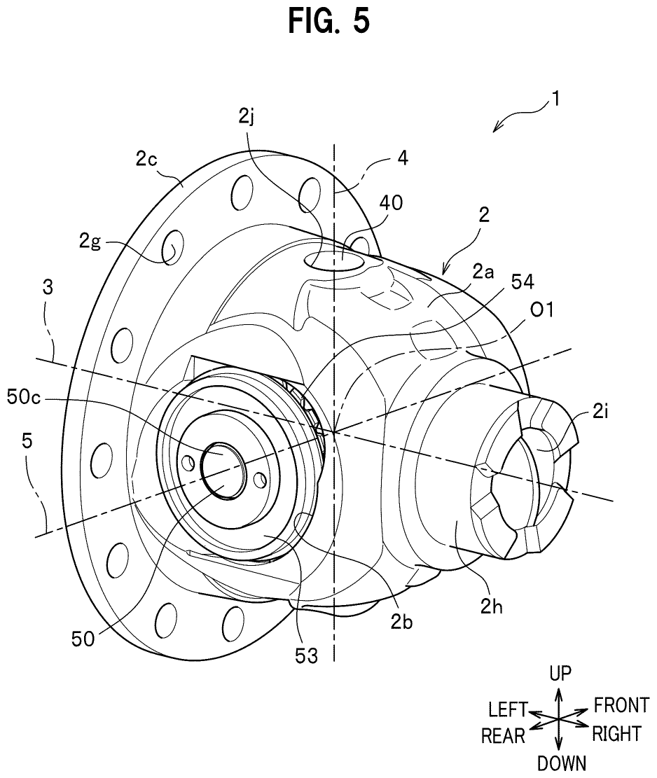

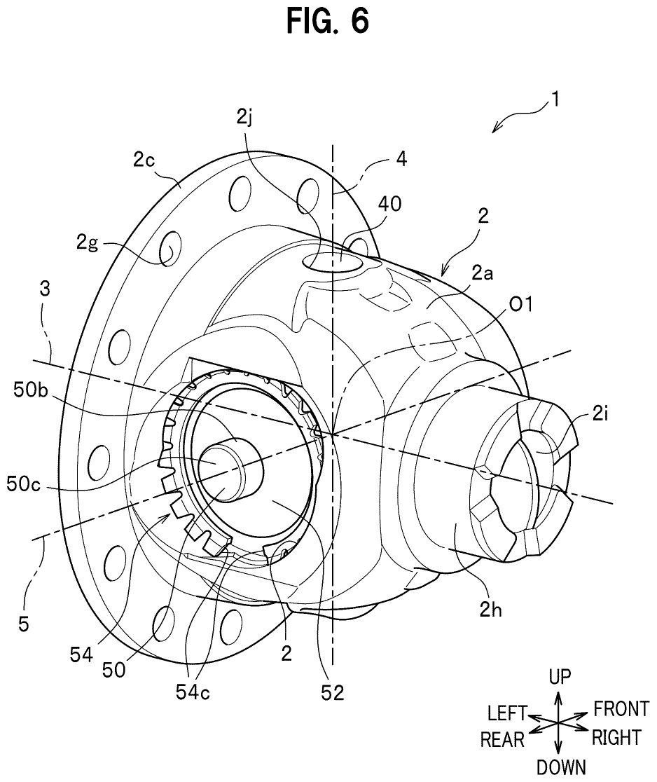

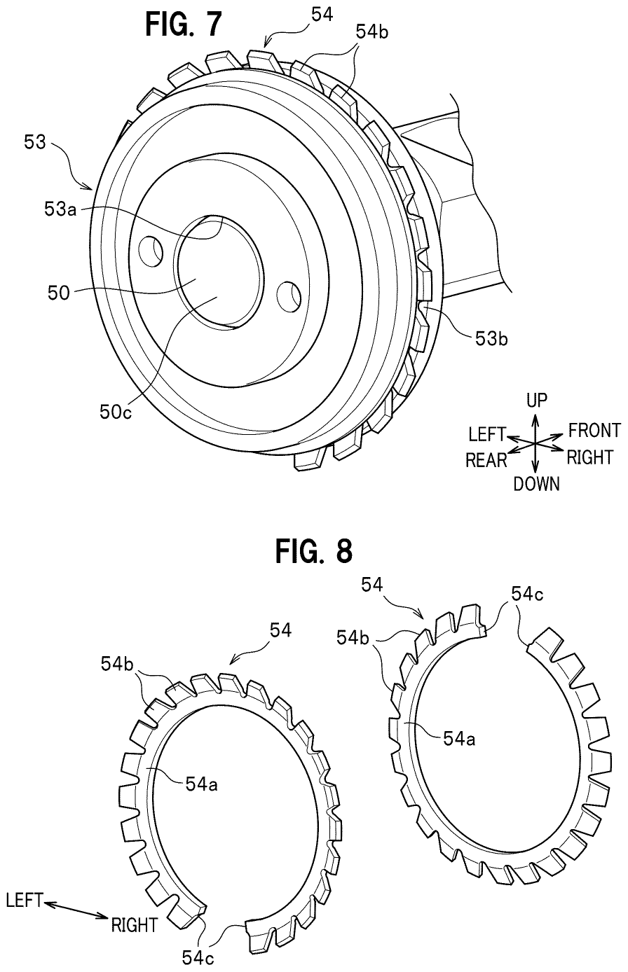

A differential device 1 according to a first embodiment of the present invention will be described with reference to FIG. 1 to FIG. 8.

In the following description, the same elements are denoted by the same reference signs, and repetitive descriptions will be omitted. In addition, in the differential device 1, portions having substantially symmetrical shapes will be described together as appropriate. In addition, in the first embodiment, a direction in which a first rotating axis 3 extends in the differential device 1 shown in FIG. 1 and FIG. 2 will be described as a left-right direction of a vehicle.

### Differential Device

The differential device 1 shown in FIG. 1 and FIG. 2 is incorporated in a final reduction gear (not shown) for reducing the speed of power which has been generated by an engine (not shown) disposed on a front side of a vehicle and which has been changed in speed by a transmission device (not shown). The differential device 1 is a device for rotating a left rear wheel and a right rear wheel at different speeds with the power transmitted via a propeller shaft. As shown in FIG. 1 or FIG. 2, the differential device 1 includes a differential case 2, a first pinion shaft 40, a second pinion shaft 50, a side gear pair 31, a first pinion gear pair 41, a second pinion gear pair 51, thrust washers 52, pinion gear supporting members 53, and snap rings 54.

### Differential Case

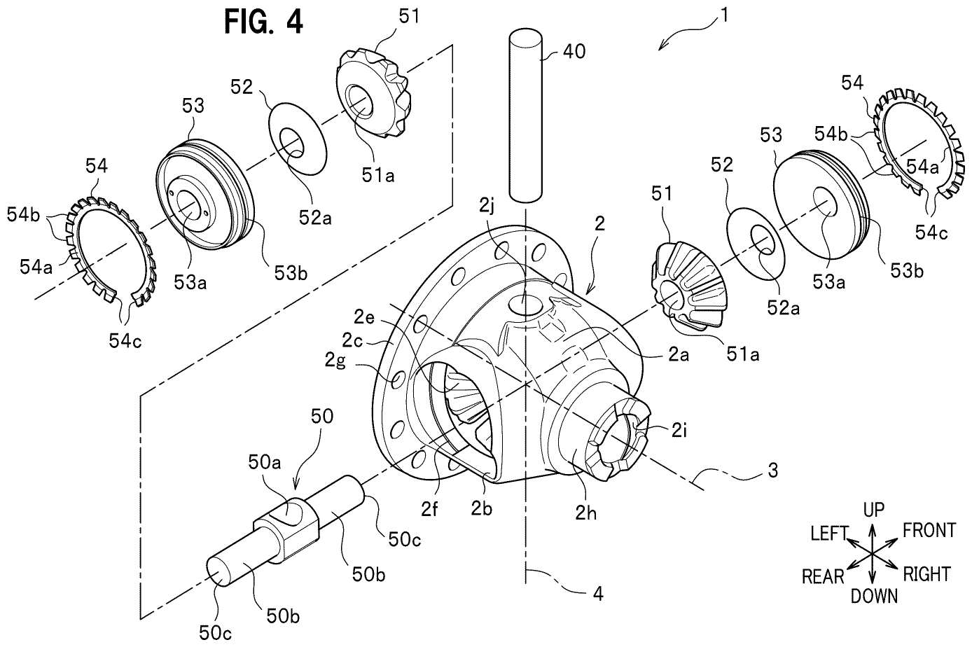

As shown in FIG. 1, FIG. 2, or FIG. 4, the differential case 2 is a casing which rotates about the first rotating axis 3 and which has a spherical shell shape along the direction of the first rotating axis 3. The differential case 2 is a gear case which can be used for a so-called four-pinion type, which houses four pinions including a pair of the first pinion gear pair 41 and a pair of the second pinion gear pair 51. The differential case 2 is composed with a single component, which is formed of one component. The differential case 2 includes a spherical shell portion 2a, an opening portion 2b, a flange portion 2c, a gear housing 2e, snap ring engagement grooves 2f, fixation holes 2g, boss portions 2h, a shaft supporting hole 2i, and a shaft insertion hole 2j.

As shown in FIG. 1, FIG. 2, and FIG. 4, the spherical shell portion 2a is a substantially cylindrical portion forming the gear housing 2e which rotatably houses the side gear pair 31, the first pinion gear pair 41, and the second pinion gear pair 51. In the spherical shell portion 2a, a plurality of the opening portions 2b are formed.

The opening portion 2b is a window which allows the side gear pair 31, the first pinion gear pair 41, and the second pinion gear pair 51 to be incorporated in the spherical shell portion 2a and which is closed by the pinion gear supporting member 53. The opening portion 2b is composed with a substantially circular-shaped insertion hole formed in a portion where a third rotating axis 5 is disposed in an outer peripheral portion of the spherical shell portion 2a. In an inner peripheral surface of the opening portion 2b, the snap ring engagement groove 2f is formed.

The snap ring engagement groove 2f is a groove with which a tooth-shaped portion 54b formed on outer peripheral portions of the snap rings 54 engages. The snap ring 54 is attached to the differential case 2 with the tooth-shaped portion 54b being engaged with the snap ring engagement groove 2f. The snap ring engagement groove 2f is composed with a substantially annular (C-shaped) groove.

The flange portion 2c is a portion for fixing a ring gear (not shown), which rotates integrally with the differential case 2, to an outer peripheral portion of the differential case 2. The flange portion 2c is formed to protrude in an annular shape at a position closer to the left end portion of the outer peripheral portion of the spherical shell portion 2a. In the flange portion 2c, a plurality of fixation holes 2g for inserting fixing tools (not shown) which fix a ring gear (not shown) to the differential case 2 are formed at appropriate intervals.

The ring gear, which is not shown, is a ring-shaped bevel gear which meshes with a drive pinion gear of a drive pinion shaft (not shown).

The drive pinion gear, which is not shown, is a gear for transmitting an output from a transmission (not shown) to the ring gear (not shown). The drive pinion shaft on which tooth portions of the drive pinion gear are integrally formed is disposed along a direction orthogonal to the axis of the ring gear.

As shown in FIG. 1 or FIG. 2, the gear housing 2e is a housing portion for housing the side gear pair 31, the first pinion gear pair 41, and the second pinion gear pair 51. The gear housing 2e is composed with a hollow housing space formed in the spherical shell portion 2a.

### wq

[symbol]

As shown in FIG. 1 to FIG. 4, the boss portion 2h is a portion onto which a bearing (not shown) rotatably supporting the differential case 2 is fitted. The boss portions 2h are composed with a pair of left and right cylindrical portions which are formed to protrude from left and right end sides of the spherical shell portion 2a. The pair of boss portions 2h are axially mounted on shaft supporting portions of a carrier with the pair of left and right bearings interposed therebetween. Hence, the differential case 2 is supported at the left and right end portions with the pair of left and right bearings interposed therebetween, and rotatably supported in the carrier to be rotatable about the first rotating axis 3. In the boss portion 2h, the shaft supporting hole 2i is formed.

As shown in FIG. 1 and FIG. 2, the shaft supporting hole 2i is a hole through which a drive shaft (not shown) is inserted. The side gear pair 31 is spline-fitted to the drive shaft, and is disposed inside the differential case 2 in a floating state.

In addition, in the spherical shell portion 2a, the shaft insertion hole 2j which rotatably supports a second rotating axis 4 disposed orthogonal to the shaft supporting hole 2i (first rotating axis 3) is formed.

### First Rotating Axis

As shown in FIG. 1 and FIG. 2, the first rotating axis 3 is a rotating axis of the differential case 2, and an axis which serves as the rotating axis of the side gear pair 31 spline-fitted to the drive shaft.

### Side Gear Pair

The side gear pair 31 is a pair of gears which mesh at right angles with the first pinion gear pair 41 and the second pinion gear pair 51. The side gear pair 31 is disposed to be rotatable about the first rotating axis 3 and is also disposed to be rotatable relative to the differential case 2. Between the side gear pair 31 and the gear housing 2e, a thrust washer 32 which biases the side gear pair 31 toward a center O1 is interposed.

### Second Rotating Axis

As shown in FIG. 2, the second rotating axis 4 is a rotating axis of the first pinion gear pair 41. The first pinion shaft 40 which supports the first pinion gear pair 41 is a shaft member which is disposed orthogonal to the first rotating axis 3 and extends in a radial direction of the differential case 2. Both end portions of the first pinion shaft 40 are fitted in the shaft insertion hole 2j.

### First Pinion Gear Pair

As shown in FIG. 2, the first pinion gear pair 41 is a pair of bevel gears which rotate about the second rotating axis 4. In the first pinion gear pair 41, an insertion hole 41a through which the first pinion shaft 40 is inserted is formed. The first pinion gear pair 41 is disposed rotatably inside the gear housing 2e. Between the first pinion gear pair 41 and the gear housing 2e, a thrust washer 42 which biases the first pinion gear pair 41 toward the center O1 is interposed.

### Third Rotating Axis

As shown in FIG. 1 and FIG. 2, the third rotating axis 5 is a rotating axis of the second pinion gear pair 51. The second pinion shaft 50 which supports the second pinion gear pair 51 is a shaft member which is disposed orthogonal to the first rotating axis 3 and the second rotating axis 4. As shown in FIG. 4, the second pinion shaft 50 includes a shaft supporting hole 50a, pinion gear supporting shafts 50b, and end surfaces 50c.

The shaft supporting hole 50a is a through-hole in which the first pinion shaft 40 is inserted and disposed.

The second pinion shaft 50 supports the second pinion gear pair 51 and the thrust washers 52 such that the second pinion gear pair 51 and the thrust washers 52 are rotatable relative to each other, and is supported in the differential case 2 by the pinion gear supporting member 53 which will be described later.

### Second Pinion Gear Pair

As shown in FIG. 1 and FIG. 4, the second pinion gear pair 51 is a pair of left and right bevel gears which rotate about the third rotating axis 5. In the second pinion gear pair 51, an insertion hole 51a through which the second pinion shaft 50 is inserted is formed. The second pinion gear pair 51 is disposed inside the gear housing 2e to be rotatable about the third rotating axis 5.

### Thrust Washer

As shown in FIG. 1 and FIG. 4, the pair of front and rear thrust washers 52 are members which are disposed between rear surfaces of the second pinion gear pair 51 and inner surfaces of the pinion gear supporting members 53 to enhance a lubrication performance between the two surfaces rotating relative to each other.

### Pinion Gear Supporting Member

As shown in FIG. 1 and FIG. 4, the pair of left and right pinion gear supporting members 53 are bearing members which support the second pinion shaft 50. The pinion gear supporting member 53 is composed with a thick lid-shaped member having a shaft insertion hole 53a which rotatably supports the pinion gear supporting shaft 50b. On an outer peripheral portion of the pinion gear supporting member 53, a snap ring mounting groove 53b for mounting the snap ring 54 is formed. The pinion gear supporting member 53 is disposed on the rear surface (the side opposite to the first rotating axis 3) of the second pinion gear pair 51 with the thrust washer 52 interposed therebetween, and functions as a supporting member which supports the second pinion gear pair 51 in the opening portion 2b of the differential case 2 from the rear surface.

The pinion gear supporting member 53 is a lid-shaped member which is detachably fixed in the opening portion 2b of the differential case 2 by engaging the snap ring 54 with the snap ring engagement groove 2f. As shown in FIG. 1, the pinion gear supporting member 53 is locked in the opening portion 2b of the differential case 2 by the snap ring 54 within a range of a fitting portion in the direction of the third rotating axis 5.

### Snap Ring

The snap ring 54 is a fixing tool for detachably attaching the pinion gear supporting member 53 to the opening portion 2b as described above. The snap ring 54 is composed with a disc spring snap ring including an arc portion 54a, a tooth-shaped portion 54b, and a tool locking portion 54c.

As shown in FIG. 4 or FIG. 8, the arc portion 54a is a portion which engages with the snap ring mounting groove 53b of the pinion gear supporting member 53. The arc portion 54a is composed with a flat-plate portion formed in an arc shape.

The tooth-shaped portion 54b is a portion which has a function of generating a biasing force along the direction of the third rotating axis 5. The tooth-shaped portion 54b is engaged with the snap ring engagement groove 2f on the differential case 2 and the snap ring mounting groove 53b on the pinion gear supporting member 53 to bias the second pinion gear pair 51 toward the center O1, thus reducing the gap in the meshing portion with the side gear pair 31. The tooth-shaped portion 54b is composed with a large number of tooth-shaped protrusions formed on an outer peripheral portion of the flat plate-shaped arc portion 54a at appropriate intervals. The tooth-shaped portion 54b extends obliquely outward from the outer peripheral portion of the arc portion 54a.

The tool locking portion 54c is a portion into which a tool (not shown) is inserted to attach or detach the snap ring 54 when the snap ring 54 is attached to or detached from the snap ring mounting groove 53b of the pinion gear supporting member 53.

### Actions and Effects of Differential Device

The differential device 1 according to the first embodiment of the present invention is basically constructed as described above, and the actions and effects of the differential device 1 will be next described with reference to FIG. 1 to FIG. 8.

As shown in FIG. 1 and FIG. 2, the side gear pair 31, the first pinion gear pair 41, and the second pinion gear pair 51 are housed in the gear housing 2e of the differential case 2 formed of a single component. For this reason, the differential case 2 makes it possible to reduce the number of components and the number of steps of assembly of the differential device 1, thereby reducing the cost. In addition, the four-pinion differential case 2 can be used in common as a two-pinion differential case, and the four-pinion differential device 1 can be produced without causing an increase in cost and a decrease in productivity.

In addition, as shown in FIG. 1 and FIG. 4, in the opening portions 2b of the differential case 2, the pinion gear supporting members 53 which support the second pinion gear pair 51 are disposed. The pinion gear supporting member 53 is attached in the opening portion 2b by engaging the snap ring 54 mounted in the snap ring mounting groove 53b of the pinion gear supporting member 53 with the snap ring engagement groove 2f.

As shown in FIG. 1, the locking position of the snap ring 54 is within a range (the opening portion 2b) of the thickness of the pinion gear supporting member 53 in which the pinion gear supporting member 53, which rotatably supports the third rotating axis 5, is fitted in the opening portion 2b. For this reason, the differential case 2 makes it possible to thin the structure around the opening portion 2b as compared with the case where the snap ring 54 is disposed on an end surface (an outer surface) of the pinion gear supporting member 53, the size and weight of the differential case 2 can be reduced.

In addition, the pinion gear supporting member 53 is attached to the opening portion 2b of the differential case 2 at a position closer to the first rotating axis 3 than the end surface 50c of the pinion gear supporting shaft 50b. For this reason, since it is possible to relatively thinly form the thickness of the differential case 2 around the pinion gear supporting member 53 and the opening portion 2b, it is possible to reduce the size and weight of the differential case 2.

In addition, the opening portion 2b of the differential case 2 is closed by the pinion gear supporting member 53, and the occupation area for an opening portion formed in the differential case 2 can be reduced in size as compared with a conventional differential case. For this reason, the differential device 1 can reduce the size of the opening portion from the inside of the differential case 2 to the outside, discharge of a lubricant reserved inside the differential case 2 to the outside can be reduced. As a result, the differential device 1 makes it possible to improve the lubrication property of mesh portions and sliding-contact portions of the first pinion gear pair 41, the second pinion gear pair 51, the side gear pair 31, and the pinion shafts.

As described above, as shown in FIG. 1 to FIG. 4, the differential device 1 according to the first embodiment of the present invention includes: the differential case 2 which rotates about the first rotating axis 3, and has a spherical shell shape along the direction of the first rotating axis 3; the first pinion gear pair 41 which rotates about the second rotating axis 4 orthogonal to the first rotating axis 3, and is disposed inside the differential case 2; the second pinion gear pair 51 which rotates about the third rotating axis 5 orthogonal to the first rotating axis 3 and the second rotating axis 4, and is disposed inside the differential case 2; the side gear pair 31 which meshes at right angles with the first pinion gear pair 41 and the second pinion gear pair 51, rotates about the first rotating axis 3, and is disposed to be rotatable relative to the differential case 2; and the at least one pinion gear supporting member 53 which is disposed on the rear surface of the second pinion gear pair 51, and is installed in the opening portion 2b formed in the differential case 2 on the side closer to the first rotating axis 3 than the end surface 50c of the pinion gear supporting shaft 50b which supports the second pinion gear pair 51 on the third rotating axis 5.

According to such a construction, the differential case 2 houses the first pinion gear pair 41, the second pinion gear pair 51, and the side gear pair 31, rotates about the first rotating axis 3, and has the spherical shell shape along the direction of the first rotating axis 3. For this reason, the differential case 2 can be composed with a single-component case body which can be used for a four-pinion type, the number of components and the number of steps of assembly can be reduced, thereby reducing the cost.

In addition, the pinion gear supporting member 53 is disposed on the rear surface of the second pinion gear pair 51, and is installed in the opening portion 2b closer to the first rotating axis 3 than the end surface 50c of the pinion gear supporting shaft 50b which supports the second pinion gear pair 51. For this reason, the periphery of the pinion gear supporting member 53 and the opening portion 2b of the differential case 2 can be thinly formed, and the size and weight of the differential case 2 can be reduced.

In addition, the pinion gear supporting member 53 can support the second pinion gear pair 51, which is rotatably supported on the third rotating axis 5, from the rear surface side, and the second pinion gear pair 51 can be supported to rotate in a stable state.

In addition, as shown in FIG. 1 and FIG. 4, the pinion gear supporting shaft 50b is a pinion shaft, the rear surface of the second pinion gear pair 51 is seated on the pinion gear supporting member 53, and the pinion gear supporting member 53 is locked to the opening portion 2b of the differential case 2 by the snap ring 54 within a range of a fitting portion in the direction of the third rotating axis 5.

Here, “within a range of a fitting portion in the direction of the third rotating axis 5” refers to within a range (the opening portion 2b) of the thickness of the pinion gear supporting member 53 in which the pinion gear supporting member 53, which rotatably supports the third rotating axis 5, is fitted into the opening portion 2b.

According to such a configuration, the pinion gear supporting member 53 is locked to the opening portion 2b of the differential case 2 by the snap ring 54, and the pinion gear supporting member 53 can be firmly fixed in the opening portion 2b without backlash.

In addition, the fixing tool for fixing the pinion gear supporting member 53 in the opening portion 2b of the differential case 2 is composed with the snap ring 54, the snap ring 54 can be firmly fixed in the middle in the thickness direction of the outer peripheral portion of the pinion gear supporting member 53.

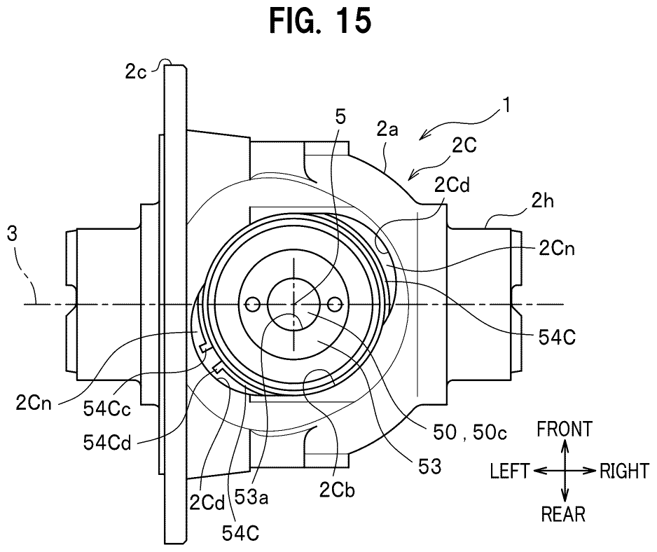

In addition, a modification of the first embodiment, as shown in FIG. 15, may employ a construction in which the snap ring 54C includes a tool locking portion 54Cc which extends from the third rotating axis 5 in a radial direction, and the differential case 2C includes a tool locking unit housing portion 2Cd which is formed to continue to the opening portion 2Cb and allow an inside and an outside of the differential case 2C to communicate with each other.

According to such a configuration, the snap ring 54C includes the tool locking portion 54Cc composed with a protrusion 54Cd which extends from the third rotating axis 5 in the radial direction, and the snap ring 54C can be easily attached and detached by enlarging the tool locking portion 54Cc of the snap ring 54. The tool locking unit housing portion 2Cd can be easily formed by cutting and forming a thinned portion 2Cn which is obtained by removing a portion of the opening portion 2Cd.

### Second Embodiment

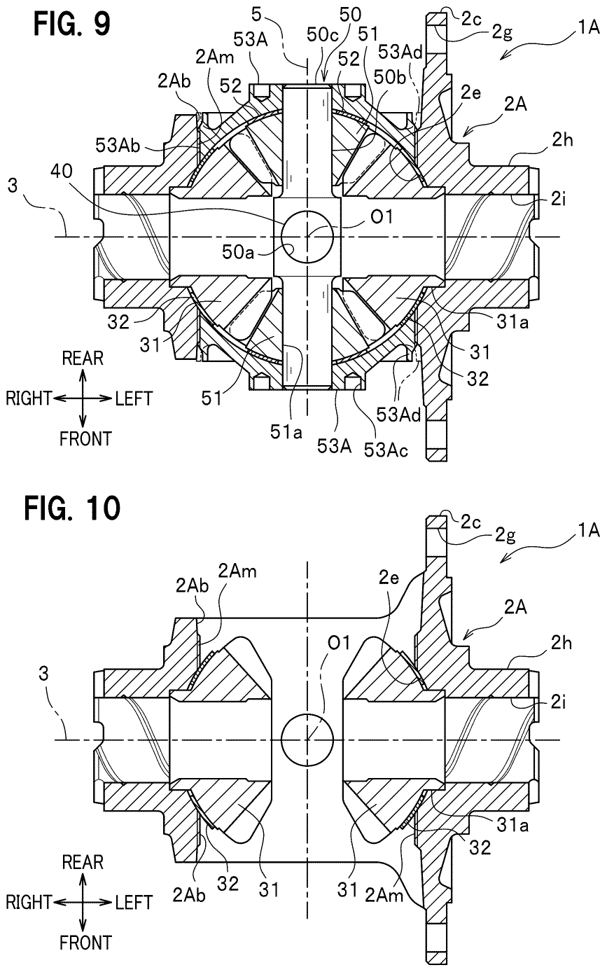

Next, a differential device 1A according to a second embodiment of the present invention will be described mainly about differences from the differential device 1 according to the first embodiment with reference to FIG. 9 to FIG. 11. Note that the constructions already described will be denoted by the same reference signs, and the descriptions thereof will be omitted.

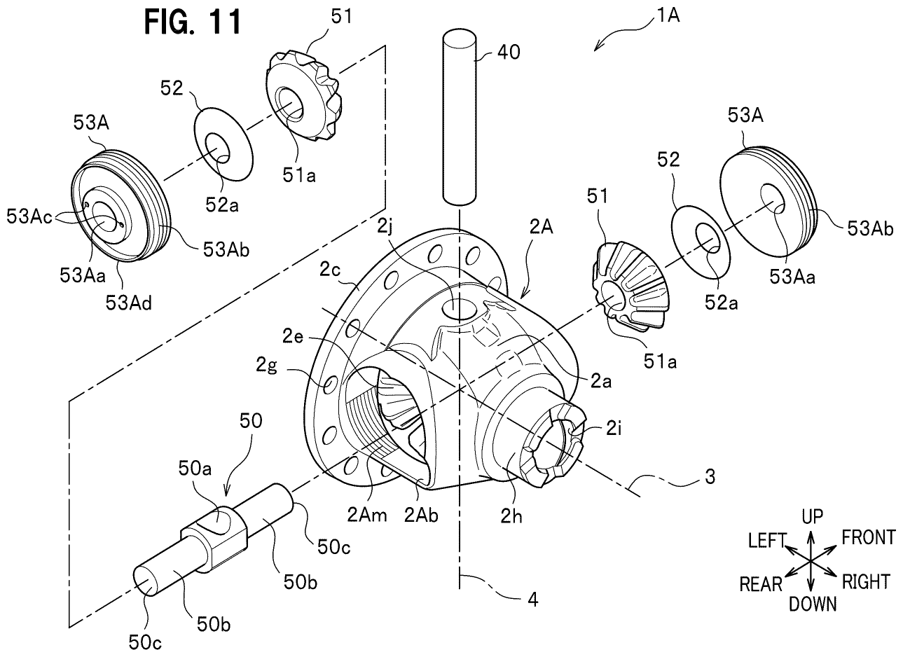

FIG. 9 is a main part-transverse sectional view showing the differential device 1A according to the second embodiment of the present invention. FIG. 10 is a main part-transverse sectional view showing the differential device 1A according to the second embodiment of the present invention, and showing a state in which a side gear pair 31 has been mounted on a differential case 2A. FIG. 11 is a main part-exploded perspective view showing the differential device 1A according to the second embodiment of the present invention.

As shown in FIG. 9 to FIG. 11, the differential device 1A according to the second embodiment of the present invention is different from the first embodiment in that a rear surface of a second pinion gear pair 51 is seated on a pinion gear supporting member 53A and the pinion gear supporting member 53A is screwed into an opening portion 2Ab of the differential case 2A, and that an annular protrusion 53Ad is clamped and fixed on an outer end portion of a female thread portion 2Am.

In this case, the female thread portion 2Am is formed on an inner wall of the opening portion 2Ab of the differential case 2A. As shown in FIG. 9 and FIG. 11, the pinion gear supporting member 53A is a lid-shaped member which closes the opening portion 2Ab. On an outer peripheral surface of the pinion gear supporting member 53A which is attached to the opening portion 2Ab, a male thread portion 53Ab on which the female thread portion 2Am is screwed and an annular protrusion 53Ad which is formed on an outer end portion of the male thread portion 53Ab are formed. The pinion gear supporting member 53A is disposed to hold a thrust washer 52 and a second pinion gear pair 51 between the pinion gear supporting member 53A and a side gear pair 31 by screwing the male thread portion 53Ab into the female thread portion 2Am.

The annular protrusion 53Ad is a locking protrusion for locking the pinion gear supporting member 53A inserted in the opening portion 2Ab to the outer end portion of the female thread portion 2Am as a rotation stopper. The annular protrusion 53Ad functions as a rotation stopper for the pinion gear supporting member 53A by screwing the pinion gear supporting member 53A into the opening portion 2Ab and then clamping and fixing the pinion gear supporting member 53A to the outer end portion of the female thread portion 2Am.

In a side surface of the pinion gear supporting member 53A, a tool engagement hole 53Ac and a shaft insertion hole 53Aa in which a second pinion shaft 50 is inserted are formed.

According to such a construction, it is necessary to screw the pinion gear supporting member 53A of the differential device 1A of the second embodiment while adjusting backlash between the second pinion gear pair 51 and the side gear pair 31. However, in this case, by locking a tool having a protruding pin into the tool engagement hole 53Ac, the screwing amount of the pinion gear supporting member 53A can be easily and favorably obtained.

In addition, a configuration in which protrusions and depressions which is even in a circumferential direction is provided on the pinion gear supporting member 53A, and a lock plate which is locked to the protrusions and depressions is provided may be employed.

The inner diameter of the opening portion 2Ab of the differential case 2A may be reduced to an inner diameter through which the side gear pair 31 and first pinion gear pair 41 incorporated therein can be inserted. In this case, a cut-out portion which is larger than the inner diameter of the female thread portion 2Am may be provided in the opening portion 2Ab of the differential case 2A.

### Third Embodiment

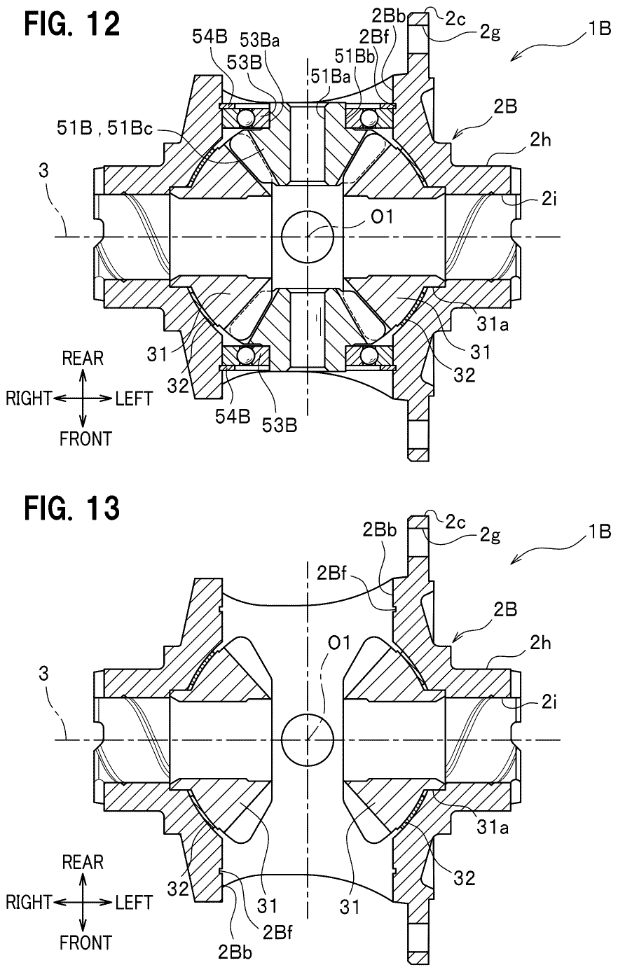

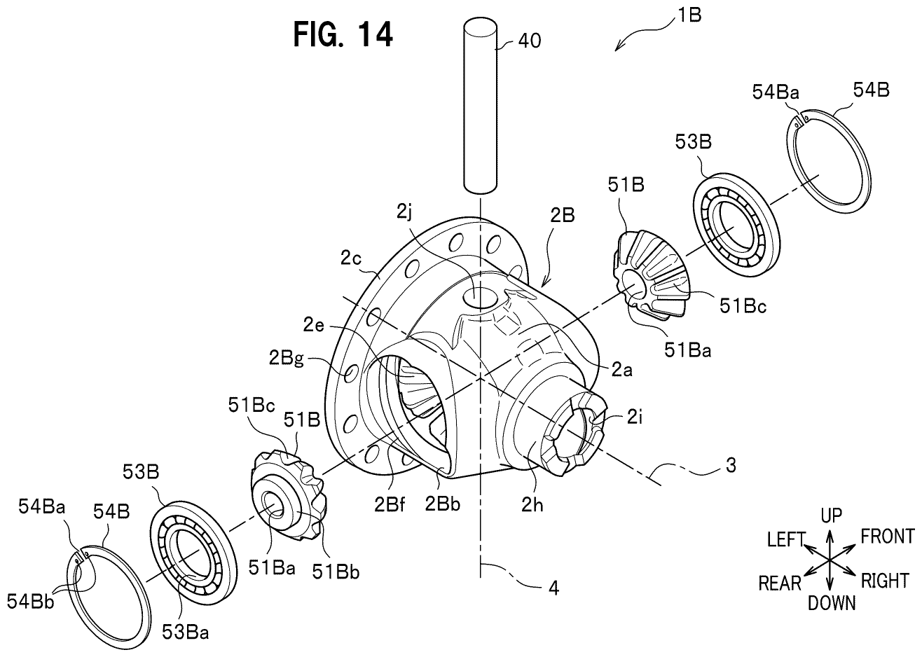

FIG. 12 is a main part-transverse sectional view showing a differential device 1B according to a third embodiment of the present invention. FIG. 13 is a main part-transverse sectional view showing the differential device 1B according to the third embodiment of the present invention, and showing a state in which a side gear pair 31 has been mounted on a differential case 2B. FIG. 14 is a main part-exploded perspective view showing the differential device 1B according to the third embodiment of the present invention.

As shown in FIG. 12 to FIG. 14, the differential device 1B according to the third embodiment of the present invention is different from the first embodiment in that a shaft portion 51Bb is provided on a rear surface of a second pinion gear pair 51B and the shaft portion 51Bb is inserted and rotatably supported in a shaft supporting hole 53Ba of a pinion gear supporting member 53B, and that the pinion gear supporting member 53B is a ball bearing.

In this way, the second pinion gear pair 51B of the differential device 1B of the third embodiment may be constructed such that the shaft portion 51Bb is provided to protrude from the rear surface, and the pinion gear supporting member 53B includes the shaft supporting hole 53Ba which rotatably supports the shaft portion 51Bb, and is inserted into an opening portion 2Bb of the differential case 2B and supported in the opening portion 2Bb by a snap ring 54B provided in the opening portion 2Bb.

In this case, as shown in FIG. 12 to FIG. 14, the second pinion gear pair 51B includes the shaft portions 51Bb on rear surfaces of tooth-shaped portions 51Bc each having a bevel tooth shape. The shaft portion 51Bb is composed with a cylindrical protrusion fitted in the shaft supporting hole 53Ba of the pinion gear supporting member 53B, and is supported in the opening portion 2Bb with the pinion gear supporting member 53B interposed therebetween.

The pinion gear supporting member 53B is composed with a bearing member such as a bearing, for example. An outer side surface (the rear surface side) of the pinion gear supporting member 53B whose outer peripheral portion is fitted in the opening portion 2Bb is held in the opening portion 2Bb by the snap ring 54B.

In the case of a two-pinion differential device, the differential case 2 can be used as it is in common. The differential case 2B can be constructed such that a portion on which the pinion gear supporting member 53B is mounted in the opening portion 2Bb is not processed to be left as a cast rough material surface.

According to such a construction, the pinion gear supporting member 53B is composed with a ball bearing and axially and rotatably supports the shaft portion 51Bb of the second pinion gear pair 51B, to thus function as a bearing member for the second pinion gear pair 51B.

### REFERENCE SIGNS LIST

1,1A,1B differential device
2, 2A, 2B, 2C differential case
2b, 2Ab, 2Bb opening portion
2d tool locking unit housing portion
3 first rotating axis
4 second rotating axis
5 third rotating axis
31 side gear pair
41 first pinion gear pair
50b pinion gear supporting shaft
50c end surface
51, 51B second pinion gear pair
51Bb shaft portion
53, 53A, 53B pinion gear supporting member
53Ba shaft supporting hole
54, 54B, 54C snap ring
54c, 54Ba, 54Cc tool locking portion

1. A differential device comprising:
a differential case to rotate about a first rotating axis and having a spherical shell along a direction of the first rotating axis;
a first pinion gear pair to rotate about a second rotating axis orthogonal to the first rotating axis and disposed inside the differential case;
a second pinion gear pair to rotate about a third rotating axis orthogonal to the first rotating axis and the second rotating axis and disposed inside the differential case;
a side gear pair meshing at right angles with the first pinion gear pair and the second pinion gear pair, to rotate about the first rotating axis, and disposed to be rotatable relative to the differential case; and
at least one pinion gear supporting member disposed on a rear surface of the second pinion gear pair and installed in an opening portion formed in the differential case and closer to the first rotating axis than an end surface of a pinion gear supporting shaft which supports the second pinion gear pair on the third rotating axis,
wherein the pinion gear supporting shaft includes a pinon shaft,
wherein the rear surface of the second pinion gear pair is seated on the pinion gear supporting member,
wherein the pinion gear supporting member is locked to the opening portion of the differential case by a snap ring within a range of a fitting portion in a direction of the third rotating axis,
wherein the snap ring includes an inner peripheral portion which engages with a snap ring mounting groove formed on an outer peripheral portion of the pinion gear supporting member, and
wherein the snap ring includes an outer peripheral portion which engages with a snap ring engagement groove formed on an inner peripheral surface of the opening portion.

2. (canceled)

3. A differential device comprising:
a differential case to rotate about a first rotating axis and having a spherical shell along a direction of the first rotating axis;
a first pinion gear pair to rotate about a second rotating axis orthogonal to the first rotating axis and disposed inside the differential case;
a second pinion gear pair to rotate about a third rotating axis orthogonal to the first rotating axis and the second rotating axis and disposed inside the differential case;
a side gear pair meshing at right angles with the first pinion gear pair and the second pinion gear pair, to rotate about the first rotating axis, and disposed to be rotatable relative to the differential case; and
at least one pinion gear supporting member disposed on a rear surface of the second pinion gear pair and installed in an opening portion formed in the differential case and closer to the first rotating axis than an end surface of a pinion gear supporting shaft which supports the second pinion gear pair on the third rotating axis,
wherein the pinion gear supporting shaft includes a pinon shaft,
wherein the rear surface of the second pinion gear pair is seated on the pinion gear supporting member, and
wherein the pinion gear supporting member includes: a male thread portion which is screwed to a female thread portion formed on the opening portion of the differential case; and an annular protrusion which is formed on outer end portion of the male thread portion and fixed to an outer end portion of the female thread portion by clamping.

4. (canceled)

5. The differential device according to claim 1,
wherein the snap ring includes a tool locking portion which extends from the third rotating axis in a radial direction, and
wherein the differential case includes a tool locking unit housing portion which is formed to continue to the opening portion and allow an inside and an outside of the differential case to communicate with each other,
wherein the tool locking unit housing portion houses the tool locking portion, and
wherein the tool locking unit housing portion is formed by cutting and forming a thinned portion formed by removing a portion of the opening portion.

6. The differential device according to claim 1,
wherein the snap ring functions as spring in a direction of the third rotating axis, and
wherein the snap ring biases the second pinion gear pair toward the first rotating axis.

7. The differential device according to claim 1,
wherein the snap ring includes:
an arc portion including a flat-plate portion which engages with the snap ring mounting groove; and
a tooth-shaped portion including multiple tooth-shaped portions formed obliquely outward on an outer peripheral portion of the arc portion at appropriate intervals and engaging with the snap ring engagement groove.
